(19) United States
(12) Patent Application Publication
(10) Pub. No.: US 2015/0246773 A1
(43) Pub. Date: Sep. 3, 2015

(54) DEVICE FOR CHANGING A FLOWPATH, AND A COLLECTION AND CONVEYING SYSTEM FOR MATERIAL

(71) Applicant: MARICAP OY, Vantaa (FI)

(72) Inventor: Göran Sundholm, Tuusula (FI)

(73) Assignee: MARICAP OY, Vantaa (FI)

(21) Appl. No.: 14/429,726

(22) PCT Filed: Sep. 4, 2013
(86) PCT No.: PCT/FI2013/050849

§ 371 Date: Mar. 19, 2015

(30) Foreign Application Priority Data
Sep. 26, 2012 (FI) 20125998

(51) Int. Cl. B65F 5/00; B65G 53/56; B65F 1/00; B65G 11/12

(52) U.S. Cl. CPC B65F 5/005; B65G 11/123; B65G 53/56; B65F 1/0093; B65F 1/0053; B65F 2001/008; B65F 2210/176

(57) ABSTRACT

Device and a system for changing a flow path. The device is connected one first pipeline and at least two other pipelines, such as a second pipeline and a third pipeline. A member is provided for changing the pathway of the medium between the one first pipeline and any of at least two other pipelines. The first pipeline is arranged to be bendable at least at the point of its free end formed to be moveable, or in the proximity of said point. The member for changing the pathway of the medium includes a member for moving the free end of the first pipeline, and a coupler for coupling and uncoupling the free end of the first pipeline with at least one other pipeline.

### BACKGROUND OF THE INVENTION

The object of the invention is a device for changing a flowpath as defined in the preamble of claim 1.

The invention also relates to a system as defined in the preamble of claim 20.

The invention relates generally to material-conveying pipes, most preferably to the conveying pipings of pneumatic material-conveying systems, such as of pneumatic waste-material-conveying systems.

In pneumatic material-conveying systems, such as in connection with waste-material-conveying systems, a solution for changing a flowpath is used, in which solution the inlet pipe is rotated in such a way that that it can be connected to two or more outlet pipes. In this case the flowpath can be changed generally at one time from one inlet pipe to one of the outlet pipes or in the opposite direction from some inlet pipe into one outlet pipe. One such solution is presented in publication CN201458197U. The publication presents a device comprising a rigid pipe part, which is rotated with a drive device. Solutions known in the art typically take up a lot of space, particularly when used in connection with pipe sizes of large diameter. In addition, in prior-art solutions, in which a pipe part is rotated, the other pipelines, to which the end of the pipe party being rotated is connected, must be arranged on the rotary rim of the end of the first pipeline.

The aim of this invention is to achieve a new type of device for changing a flowpath in material-conveying piping, by the aid of which device the drawbacks of prior art are avoided. Another aim of the invention is to achieve a device for use in connection with material-conveying systems, according to which the pipelines intended to be coupled together can be arranged more flexibly than before in relation to each other. Yet another aim is to achieve an apparatus for use in the collection and conveying of wastes or material for recycling.

### BRIEF DESCRIPTION OF THE INVENTION

The device according to the invention is characterized by what is stated in the characterization part of claim 1.

The device according to the invention is also characterized by what is stated in claims 2-19.

The system according to the invention is characterized by what is stated in the characterization part of claim 20.

The solution according to the invention has numerous important advantages. By arranging the first pipeline to be flexible, an effective and operationally reliable bending motion of the free end is achieved. By arranging the free end of the first pipeline to be moveable and arranging moving means for moving the free end, an effective and operationally reliable solution for changing a flowpath is achieved. The arrangement is multipurpose and permits different layouts of the pipelines to be used in flowpaths. With the device according to the invention a number of other pipelines can be e.g. disposed side-by-side in such a way that the longitudinal axis of them intersects the same transverse straight line. By arranging moving devices, which can move the free end of the first pipeline in a number of directions, a flexible layout solution of other pipelines is enabled. By arranging a number of moving devices, the movement distance can be divided between the drive devices, in which case fast and precise movements of the drive devices and of the free end of the first pipeline are achieved, if necessary. By arranging a device according to the invention at the junction point of the pipes, the passage and flow of material at the junction point can be efficiently controlled. By arranging a sleeve means as the coupling device, an operationally reliable connection between the first pipeline and any one of the other pipelines can be achieved. Correspondingly, an operationally reliable disconnection is achieved between the aforementioned pipelines. By using a cylinder-piston combination as the moving device of the coupling means, an efficient movement of the coupling means is achieved. By the aid of the solution the occurrence of blockages at the junction point can be effectively avoided. In principle the solution also enables the changing of more flowpaths than presented. The device according to the invention is very well suited for use in connection with material collection and conveying systems, such as in connection with pneumatic or other material-conveying systems. Owing to its easy and fast controllability and operation, the device according to the invention is suited for use, inter alia, in connection with material-conveying systems, in which material is conveyed in a sorted manner from one conveying pipe to a number of other conveying pipes or containers.

### BRIEF DESCRIPTION OF THE FIGURES

In the following, the invention will be described in more detail by the aid of an embodiment with reference to the attached drawings, wherein

FIG. 1 presents a partially sectioned side view of an embodiment of the device according to the invention,

FIG. 2 presents a device according to an embodiment of the invention, partially sectioned along the line II-II of FIG. 1,

FIG. 3 presents a partially sectioned side view of a device according to an embodiment of the invention, in a second operating mode,

FIG. 4 presents a device according to an embodiment of the invention, partially sectioned along the line IV-IV of FIG. 3,

FIG. 5 presents a partially sectioned side view of a device according to an embodiment of the invention, in a third operating mode,

FIG. 6 presents a device according to an embodiment of the invention, partially sectioned along the line VI-VI of FIG. 5,

FIG. 7 presents a partially sectioned side view of a device according to an embodiment of the invention, in a fourth operating mode,

FIG. 8 presents a device according to an embodiment of the invention, partially sectioned along the line VIII-VIII of FIG. 7,

FIG. 9 presents a partially sectioned side view of a device according to a second embodiment of the invention,

FIG. 10 presents a device according to the second embodiment of the invention, partially sectioned along the line X-X of FIG. 9,

FIGS. 10a, 10b and 10c present a device according to the second embodiment of the invention, in different operating modes in the projection according to FIG. 10.

FIG. 11 presents a simplified detail of a device according to the second embodiment of the invention,

FIG. 12 presents a system, in which a device according to the invention is applied,

FIG. 13 presents a second system, in which a device according to the invention is applied, and

FIG. 14 further presents an apparatus, in which a device according to the invention is applied.

### DETAILED DESCRIPTION OF THE INVENTION

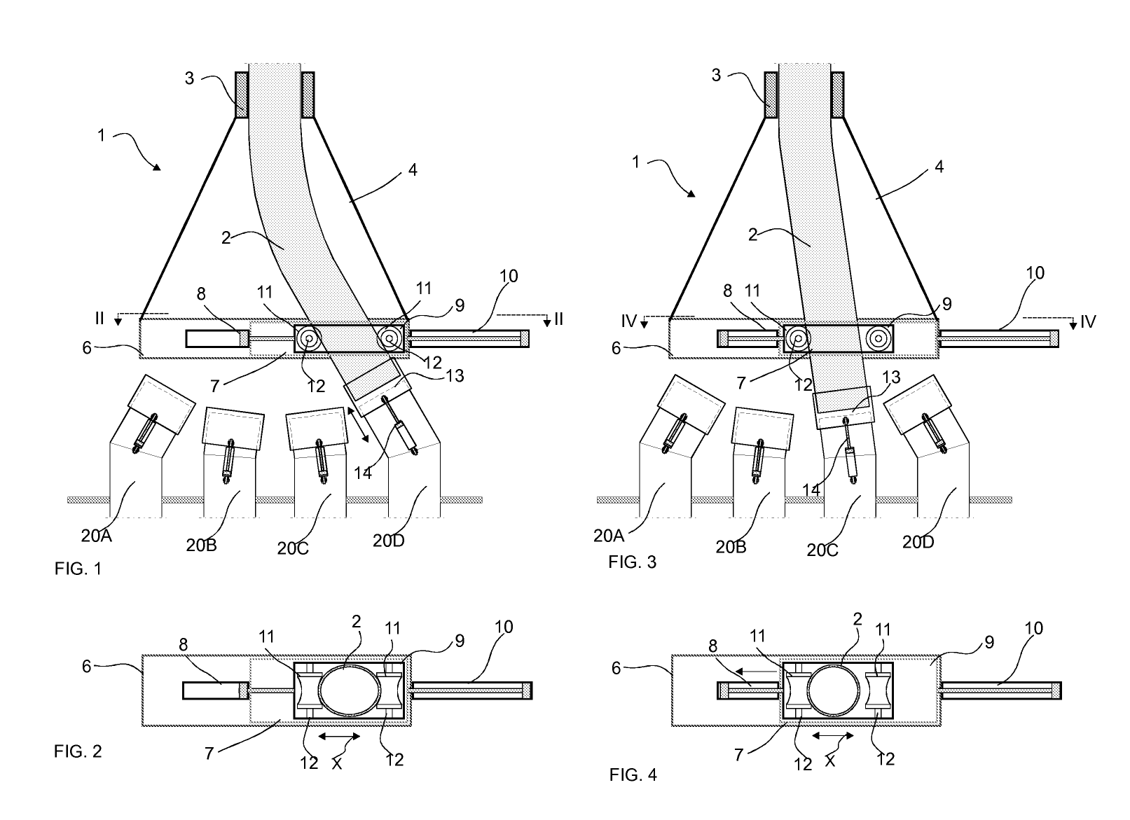

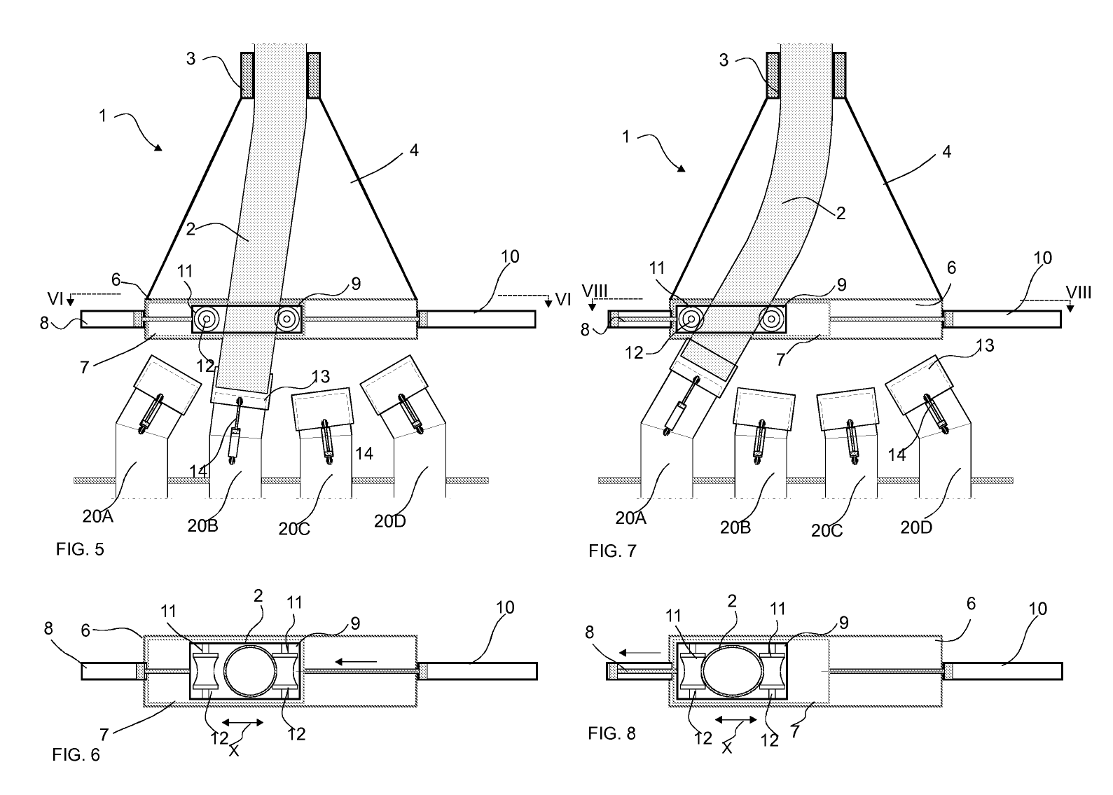

FIG. 1 presents an embodiment of the device 1, according to the invention, for changing a flowpath. To the device 1 are connected one first pipeline 2, at least two other pipelines 20A, 20B, 20C, 20D, such as a second pipeline 20A and a third pipeline 20B, and also means for changing the pathway of the medium between the one first pipeline and any of the at least two other pipelines 20A, 20B, 20C, 20D. The means for changing the pathway of the medium comprise means 6, 7, 8, 9, 10, 11 for moving the free end of the first pipeline 2, and coupling means 13, 14 for coupling and uncoupling the free end of the first pipeline 2 with at least one other pipeline 20A, 20B, 20C, 20D. In FIG. 1 is one first pipeline 2, which is supported with a sleeve part 3 in the top part of the figure. The first pipeline 2 is arranged to be bendable at least at the point of its free end formed to be moveable. In this case the first pipeline can be moved and bent at least from part of the area of the pipeline that extends from the sleeve 3 to the free end of the first pipeline 2. The device has a protective wall 4, which extends from the sleeve part 3 downwards into the support frame 6. In the figure the protective wall is the shape of a truncated cone and tapers towards the top part and the sleeve means 3. Arranged in the bottom part of the device at a distance from the support frame are pipelines 20A, 20B, 20C, 20D, to the point of the free ends of each of which the free end of the first pipeline 2 can be moved and aligned. The device comprises coupling means 13, 14, by the aid of which the free end of the first pipeline 2 and the free end of any one of the other pipelines 20A, 20B, 20C, 20D can be coupled together for forming a joint between the first pipeline and any one of the other pipelines. FIG. 1 presents four other pipelines 20A, 20B, 20C, 20D. In FIGS. 1-8 the other pipelines 20A, 20B, 20C, 20D are arranged side-by-side.

In the embodiment of the figure the moving means of the free end of the first pipeline 2 comprise at least one support means 11, 11A, 11B, which is arranged to be moved by at least one drive means 8, 10. The free end of the first pipe means 2 is arranged in the figure between the support surfaces of at least one support means 11, in which case the support means 11 supports the wall of the free end of the pipeline 2 from at least two directions.

At least one support means 11, 11A, 11B is arranged in the actuator body 7, 9, which is moved with at least one drive means 8, 10. In the embodiment of the figures the actuator body 7 is arranged on the support frame 6 to be moveable in relation to support frame. The actuator body 7 is arranged in the support frame 6 to be moved with a first drive means 10. The actuator body 7 is moved with the drive means 10, which is e.g. a cylinder-piston unit or a lead-screw unit. The drive means 8, 10 can be e.g. pressure-medium operated or electrically-operated.

In the embodiment of the figure is also a second actuator body 9 arranged to be moveable in the first actuator body 7 with a second drive means 8.

The free end of the first pipeline 2 is arranged to be moveable between at least one second pipeline 20A, 20B, 20C, 20D and the proximity of the access opening of at least one other pipeline.

The coupling means 13, 14 comprise a sleeve part, which is arranged to be moveable between a first position and a second position, and the moving means 14 of the sleeve part. The sleeve part is arranged around the free end of the second of the pipelines 20A, 20B, 20C, 20D to be coupled with and moveably in the longitudinal direction. When the free end of the first pipeline 2 is brought to the point of the free end of one of the other pipelines 20A, 20B, 20C, 20D, the sleeve part of the coupling means 13, 14 is moved with the moving means 14 of the sleeve part around also the free end of the first pipeline 2, in which case the ends of both the pipelines 2; 20A, 20B, 20C, 20D to be coupled together are inside the sleeve in such a way that a joint forms. Alternatively, it can be conceived that the coupling means are in connection with the first pipeline 2. FIGS. 1-8 present how with an embodiment of the device according to the invention each of the other pipelines 20A, 20B, 20C, 20D are coupled together one at a time with the first pipeline 2. At the same time the operation of the moving means 7, 8, 9, 10 of the free end of the first pipeline 2 is illustrated. In the embodiment of the figures the free end of the first pipeline 2 is moved, by bending it, with the aid of the support means 11 and the moving devices 7, 8, 9, 10, in such a way that the support means 11 is moved linearly while supported on the support frame 6. In the embodiment of FIGS. 1-8, there are two support means 11. In the figures the support means 11 are roller means, which are supported by their shafts 12 on the actuator body 9. The support surface, at least on the side of the first pipeline, of the support means is formed to correspond to the outer surface of the pipeline. In the embodiment of the figures the support surface is configured to correspond to the radius of curvature of the wall of the pipe means. In the embodiment of the figures the first actuator body 7 is moved in relation to the support frame 6 with the first drive means 10. The second actuator body 9 is arranged to move along with the first actuator body 7. The second actuator body 9, and the support means 11 along with it, is moved with the second drive means 8 in relation to the first actuator body 7. In the embodiment of the figures the movement of the actuator bodies 7, 9 and the free end of the pipe 2 along with them is described in the projection of FIGS. 2, 4, 6 and 8 with the arrow X. In principle, it is possible that the support means 11 is moved directly or just one actuator body. In this case the stroke length of the drive means would in some cases form to be rather long, which can slow down the operation of the device.

According to an embodiment of the invention the free end of the first pipeline 2 is therefore arranged to be moveable in at least one transverse direction with respect to the first pipeline 2.

The first pipeline 2 is arranged to be bendable or turnable at least at the point of its free end formed to be moveable. In this case the pipe part can be moved and turned/bent from the area that extends from the sleeve 3 to the free end of the first pipeline. According to one embodiment the first pipeline 2 is of plastic material or of a material that is bendable or flexible. According to one embodiment the material of the pipeline is polyethylene or some other suitable material. The structure can be of also another suitable material. A bending point or bending points can be formed in the pipeline, at which point(s) the free end of the pipeline 2 bends when it is moved with the moving means.

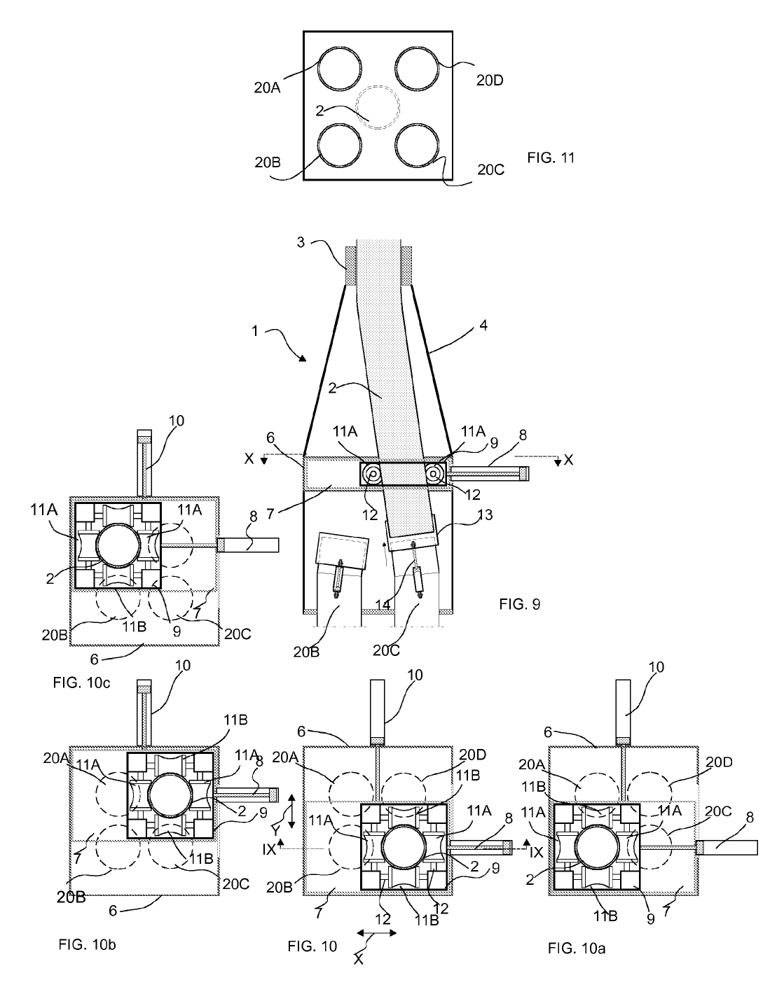

In the embodiments of FIGS. 9, 10, 10a, 10b, 10c and 11 the free end of the first pipeline 2 is configured to be moveable also in one second direction that is transverse with respect to the first direction. In the embodiment of the figures the other pipelines 20A, 20B, 20C, 20D are arranged in two rows on the transverse plane at a right angle to the longitudinal direction of the pipes, in each of which rows are two pipes 20A, 20D; 20B, 20C. The free end of the first pipe part 2 can in this case be moved, according to FIGS. 9, 10, 11, both in a first transverse direction (the X direction) and in a second transverse direction (the Y direction). The first actuator body 7 is arranged to be moved with respect to the support frame 6 in the Y-direction of the arrow with the first drive means 10 and the second actuator body 9 with respect to the first actuator body 7 in the X-direction of the arrow with the second drive means 8. In FIG. 10 the free end of the first pipeline 2 has been moved to the point of another pipeline 20C.

With the solution of the embodiment of FIGS. 9, 10, 10a, 10b, 10c and 11 relatively short movement distances are achieved for the free end of the first pipeline 2, in which case also the space requirement is small and the operating speed of the moving means is good. In FIG. 10a the free end of the first pipeline 2 has been moved to the point of another pipeline 20B. In FIG. 10b the free end of the first pipeline 2 has been moved to the point of another pipeline 20D. In FIG. 10c the free end of the first pipeline 2 has been moved to the point of another pipeline 20A.

The free end of the first pipeline 2 is arranged to be moveable in relation to the support means 11, 11A, 11B. According to one embodiment the support means 11, 11A, 11B is a roller means, in which case the movement between the pipeline 2 and the support means 11 is low-friction and the support means does not forcefully wear the wall of the first pipe part 2. In the embodiments of FIGS. 9-11 the wall of the first pipeline 2 is supported between four support means 11A, 11B.

At least two other pipelines 20A, 20B, 20C, 20D are arranged consecutively and/or side-by-side in the transverse direction at a right angle with respect to the longitudinal direction of the pipelines.

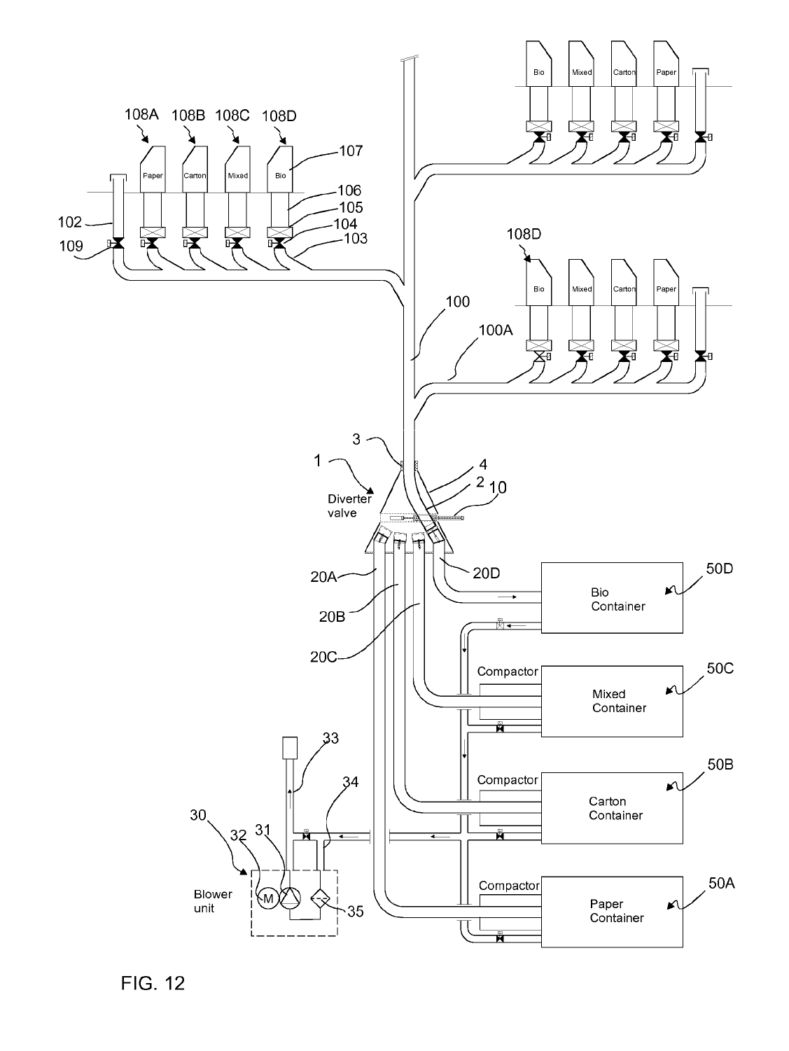

According to one embodiment the first pipeline 2 being a conveying pipe of a pneumatic pipe conveying system for material or a pipeline connecting to the conveying pipe 100 is arranged to be bendable at least at the point of its free end formed to be moveable and at least one other pipeline 20A, 20B, 20C, 20D is a conveying pipe leading to a container 50A, 50B, 50C, 50D of the pneumatic pipe conveying system for material. Such an apparatus is presented in FIG. 12. With the device according to the invention effective arrangements for changing a material pathway can be achieved in the collection and conveying of material. In the embodiment of FIG. 12 sorted material, e.g. sorted waste material, can be infed from the inlet points 108A, 108B, 108C, 108D for conveying in one conveying pipe 100. From the conveying pipe the sorted material batches are guided to the container 50A, 50B, 50C, 50D according to each sorted material batch being conveyed by using the device according to the invention. In this case couplings are formed, according to the sorted material batches being conveyed, between the free end of the first pipeline 2 and the pipelines 20A, 20B, 20C, 20D running to the different containers 50A, 50B, 50C, 50D. The partial-vacuum unit 30 in the embodiment of the figure is used in the conveying of material from the inlet points 108A, 108B, 108C, 108D, the suction side of the partial-vacuum generator 31, said partial-vacuum generator being driven with the drive device 32, of which partial-vacuum unit is connected to the suction pipe 34, from where a connection can be opened and closed to each container 50A, 50B, 50C, 50D and onwards via any of the pipes 20A, 20B, 20C, 20D and the first pipeline 2 to the conveying pipe 100 for material and onwards to an inlet point. In the embodiment of the figure a feed-in container 107 is in connection with the inlet points, from which feed-in container is a connection to an inlet chute 106. In connection with an inlet chute is a material shaper, such as a rotary shaper, with which the material can be shaped and compacted into an inlet pipe 103 and conveying pipe 100 that are smaller in diameter than the inlet chute. A feed valve 104 is between the input point 108 and the conveying pipe, with which valve the infeeding of material into the conveying piping is regulated. The material-conveying piping also comprises a replacement air branch coupling 102, which is per se prior art and which comprises a replacement air valve 109. The device according to the invention also functions in other apparatuses intended for material conveying and collection. In the situation of FIG. 12 the material from the inlet point 108D, containing biowaste, of the conveying pipe branch 100A is conveyed via the conveying pipe branch 100A and the conveying pipe 100, via the coupling formed by the free end of the first pipeline 2 of the connection formed by the device according to the invention, to the pipeline 20D leading to the container 50D intended for biowaste. The material remains in the container 50D and the transporting air travels along the piping 34 to the blowing side of the partial-vacuum generator and into the exhaust pipe 33. The transporting air can be filtered with a filtering means 35 arranged in the piping.

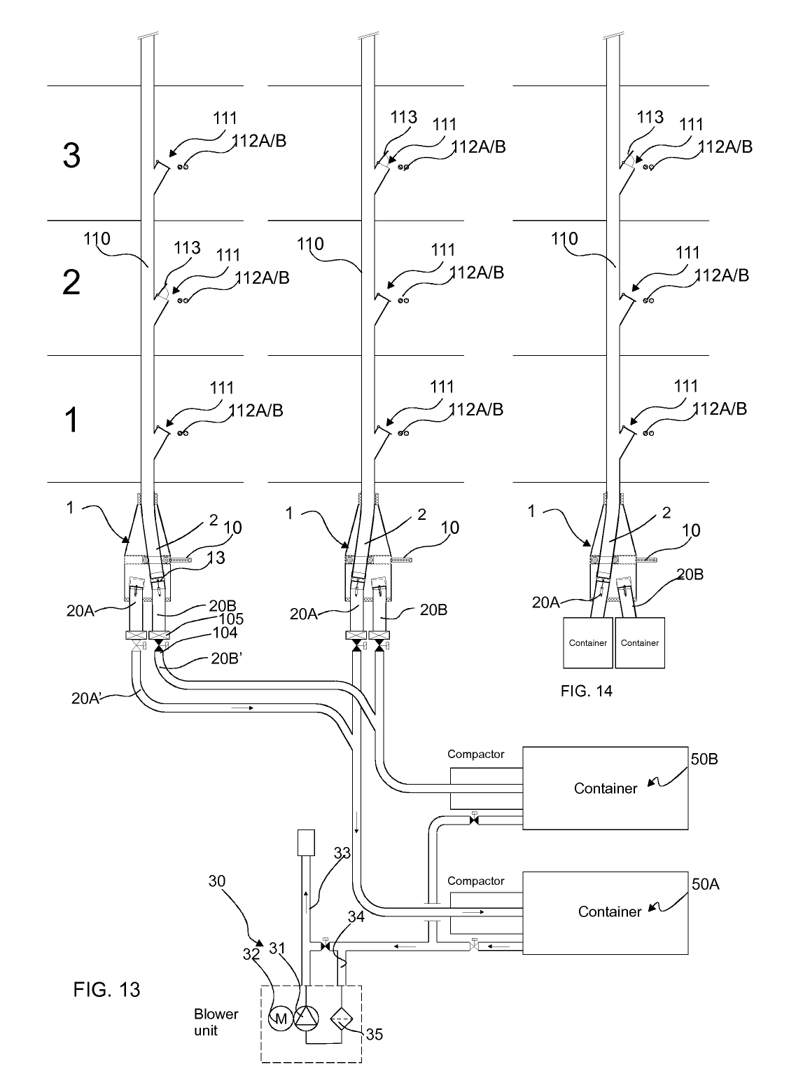

According to a second embodiment the device according to the invention is used in connection with a waste chute or other inlet pipe to conduct material selectively into a container or into a pipeline. Such solutions are presented in FIGS. 13 and 14.

FIG. 13 presents a part of the system, in which material can be conveyed from the inlet points 111 from the waste chutes 110 selectively with the device 1 according to the invention to intermediate containers arranged in the bottom end of the waste chute, the other pipelines 20A, 20B functioning as such intermediate containers. In connection with an inlet point 111 is a selector switch 112A/B, with which the type of material, i.e. the sorted batch, to be fed in is specified. The person taking the material selects the type of material to be fed in with the selector switch 112A/B, e.g. by pressing a pushbutton, as a consequence of which the hatch 113 of the aperture of the inlet point 111 opens and the material can be fed in from the aperture into the refuse chute 110. On the basis of the pressing of the selector switch, the free end of the first pipeline 2 connected to the bottom part of the inlet chute of the device 1 arranged in the bottom part of the inlet chute, which pipeline is arranged to be bendable at least at the point of its free end formed to be moveable, is moved to connect to the desired other pipeline 20A, 20B, into which the material fed in is conducted. A material shaper 105, such as a rotary shaper, is arranged after the other pipelines 20A, 20B, with which material shaper the material can be shaped and compacted to fit better into a conveying pipe that is smaller in diameter. The figure also presents a feed valve 104, with which the infeed of material from the other pipelines into the conveying pipe 20A′, 20B′ leading to the container 50A, 50B is regulated. In the system of the figure, material is conveyed at least partly by pneumatic pipe conveying to the containers 50A, 50B. The figure presents a partial-vacuum unit 30, the suction side of the partial-vacuum generator 31 of which, said partial-vacuum generator being driven with the drive device 32, is connected to the suction pipe 34, from where a connection can be opened and closed to each container 50A, 50B, and onwards via any of the pipes 20A′, 20B′ and onwards to the other pipelines 20A, 20B in the bottom part of the desired inlet chute. In the embodiment of FIG. 13 the second of the other pipelines can be emptied when the inlet chute and thus the first pipeline 2 is connected to some other pipeline. In FIG. 13 the first other pipeline 20A is emptied when the first pipeline 2 is connected to the second other pipeline 20B.

According to one embodiment material is configured to be conveyed from a first pipeline 2 into at least one other pipeline 20A, 20B, 20C, 20D by means of gravity. FIG. 14 presents a refuse chute 110, which comprises a number of inlet points 111, typically arranged e.g. on different floors. In connection with an inlet point is a selector switch 112A/B, with which the type of material, i.e. the sorted material batch, to be fed in is specified. The person taking the material selects the type of material to be fed in with the selector switch 112A/B, e.g. by pressing a pushbutton, as a consequence of which the hatch 113 of the aperture of the inlet point 111 opens and the material can be fed in from the aperture into the refuse chute 110. On the basis of the pressing of the selector switch, the free end of the first pipeline 2 connected to the bottom part of the inlet chute of the device 1 arranged in the bottom part of the inlet chute is moved to connect to the desired other pipeline 20A, 20B, which conducts the sorted material batch to the intended container. The material is conveyed from the inlet point by gravity along the refuse chute into the selected container.

In this case the first pipeline 2 is a pipeline connecting to the inlet pipe or inlet chute 110 of a pipe conveying system for material, and one second pipeline 20A, 20B is configured to conduct the material into a container 50A, 50B. There can be a number of containers, in which case the device according to the invention for changing the pathway of a medium has a number of other pipelines 20A, 20B, 20C, 20D, to which the first pipeline 2 can be selectively connected. Correspondingly, the moving devices 10 of the free end of the first pipeline 2 are configured according to the application site.

The invention thus relates to a device for changing a flowpath, to which device are connected one first pipeline 2, at least two other pipelines 20A, 20B, 20C, 20D, such as a second pipeline 20A and a third pipeline 20B, and also means for changing the medium pathway between the one first pipeline and any of at least two other pipelines 20A, 20B, 20C, 20D. The first pipeline 2 is arranged to be bendable at least at the point of its free end formed to be moveable, or in the proximity of said point, that the means for changing the pathway of the medium comprise means 6, 7, 8, 9, 10, 11 for moving the free end of the first pipeline 2, and coupling means 13, 14 for coupling and uncoupling the free end of the first pipeline 2 with at least one other pipeline 20A, 20B, 20C, 20D.

According to one embodiment the moving means 6, 7, 8, 9, 10, 11 of the free end of the first pipeline 2 comprise at least one support means 11, 11A, 11B, which is arranged to be moved by at least one drive means 8, 10.

According to one embodiment at least one support means 11, 11A, 11B is arranged in the actuator body 7, 9, which is moved with at least one drive means 8, 10.

According to one embodiment the device comprises a first actuator body 7, which is moved with a first drive means 10, and a second actuator body 9, which is moved with a second drive means 8.

According to one embodiment that the free end of the first pipeline 2 is arranged to be moveable between at least one second pipeline and the proximity of the access opening of at least one other pipeline.

According to one embodiment the coupling means 13, 14 comprise a sleeve part 13, which is arranged to be moveable between a first position and a second position, and the moving means 14 of the sleeve part 13.

According to one embodiment the sleeve part 13 is, in the second position, i.e. in the coupling position, around the free end of the first pipeline 2 and the end of at least one other pipeline 20A, 20B, 20C, 20D, in which case a joint of the first pipeline 2 with at least one other pipeline 20A, 20B, 20C, 20D is formed.

According to one embodiment the free end of the first pipeline 2 is arranged to be moveable in at least one transverse direction with respect to the first pipeline.

According to one embodiment the free end of the first pipeline 2 is arranged to be moveable in at least one second transverse direction with respect to the first direction of movement.

According to one embodiment the free end of the first pipeline 2 is arranged to be moveable in relation to the support means 11, 11A, 11B.

According to one embodiment the support means 11, 11A, 11B is a roller means.

According to one embodiment the first pipeline 2 comprises flexible material, e.g. plastic material, at least in the section of it that is arranged to be moveable.

According to one embodiment the device comprises a support frame 6, in relation to which the first actuator body 7 and/or the second actuator body 9 is arranged to move.

According to one embodiment that the free end of the first pipeline 2 and the end of at least one other pipeline 20A, 20B, 20C, 20D are arranged face-to-face at least when forming a joint.

According to one embodiment at least two other pipelines 20A, 20B, 20C, 20D are arranged consecutively and/or side-by-side in the transverse direction at a right angle with respect to the longitudinal direction of the pipelines.

According to one embodiment the first pipeline 2 is a conveying pipe of a pneumatic pipe conveying system for material or a pipeline connecting to the conveying pipe 100 and at least one other pipeline 20A, 20B, 20C, 20D is a conveying pipe leading to a container 50A, 50B, 50C, 50D of the pneumatic pipe conveying system for material.

According to one embodiment the first pipeline 2 is a pipeline connecting to the inlet pipe or inlet chute of a pipe conveying system for material, and one other pipeline 20A, 20B is configured to conduct the material into a container 50A, 50B.

According to one embodiment material is configured to be conveyed from a first pipeline 2 into at least one other pipeline 20A, 20B, 20C, 20D by means of gravity.

According to one embodiment material is configured to be conveyed from a first pipeline 2 into at least one other pipeline 20A, 20B, 20C, 20D by means of suction/a pressure difference.

The invention also relates to a material collection and conveying system, in which material is infed in an inlet point and is conveyed along pipelines, such as conveying pipes or inlet chutes, under gravity and/or with a partial vacuum/pressure difference into one or more containers or to further processing.

In the system material is configured to be conveyed from one first pipeline 2 selectively with a device 1 for changing the pathway of a medium between the one first pipeline 2 and any of at least two other pipelines 20A, 20B, 20C, 20D, that the first pipeline 2 is arranged to be bendable at least at the point of its free end formed to be moveable, or in the proximity of said point, and that in the device 1 the means for changing the pathway of the medium comprise means 6, 7, 8, 9, 10, 11 for moving the free end of the first pipeline 2, and coupling means 13, 14 for coupling and uncoupling the free end of the first pipeline 2 with at least one other pipeline 20A, 20B, 20C, 20D.

According to one embodiment the system is a collection and conveying system for waste material or material for recycling. The waste material is e.g. household waste, such as mixed waste, paper, cardboard or biowaste packed into bags.

It is obvious to the person skilled in the art that the invention is not limited to the embodiments presented above, but that it can be varied within the scope of the claims presented below. The characteristic features possibly presented in the description in conjunction with other characteristic features can if necessary be used separately to each other.

1-20. (canceled)

21. A device for changing a flowpath, comprising:
a device operatively connected one first pipeline;
at least two other pipelines connected to the device, such as a second pipeline and a third pipeline; and
means for changing the pathway of the medium between the one first pipeline and any of at least two other pipelines, which first pipeline is arranged to be bendable at least at the point of its free end formed to be moveable, or in the proximity of said point, said means for changing the pathway of the medium comprises:
means for moving the free end of the first pipeline; and
coupling means for coupling and uncoupling the free end of the first pipeline with at least one other pipeline;
wherein the moving means of the free end of the first pipeline comprises:
at least one support means, arranged to be moved by at least one drive means and a free end of the first pipeline is arranged to be moveable in relation to the support means.

22. The device according to claim 21, wherein at least one support means is arranged in the actuator body, which is moved with at least one drive means.

23. The device according to claim 21, wherein the device comprises a first actuator body, which is moved with a first drive means, and a second actuator body, which is moved with a second drive means.

24. The device according to claim 21, wherein the free end of the first pipeline is arranged to be moveable between at least one second pipeline and the proximity of the access opening of at least one other pipeline.

25. The device according to claim 21, wherein the coupling means comprise a sleeve part, which is arranged to be moveable between a first position and a second position, and the moving means of the sleeve part.

26. The device according to claim 25, wherein the sleeve part is, in the second position, i.e. in the coupling position, around the free end of the first pipeline and the end of at least one other pipeline, in which case a joint of the first pipeline with at least one other pipeline is formed.

27. The device according to claim 21, wherein the free end of the first pipeline is arranged to be moveable in at least one transverse direction with respect to the first pipeline.

28. The device according to claim 27, wherein the free end of the first pipeline is arranged to be moveable in at least one second transverse direction with respect to the first direction of movement.

29. The device according to claim 21, wherein the support means is a roller means.

30. The device according to claim 21, wherein the first pipeline comprises flexible material, e.g. plastic material, at least in the section of it that is arranged to be moveable.

31. The device according to claim 21, wherein the device comprises a support frame, in relation to which the first actuator body and/or the second actuator body is arranged to move.

32. The device according to claim 21, wherein the free end of the first pipeline and the end of at least one other pipeline are arranged face-to-face at least when forming a joint.

33. The device according to claim 21, wherein at least two other pipelines are arranged consecutively and/or side-by-side in the transverse direction at a right angle with respect to the longitudinal direction of the pipelines.

34. The device according to claim 21, wherein the first pipeline is a conveying pipe of a pneumatic pipe conveying system for material or a pipeline connecting to the conveying pipe, and at least one other pipeline is a conveying pipe leading to a container of the pneumatic pipe conveying system for material.

35. The device according to claim 21, wherein the first pipeline is a pipeline connecting to the inlet pipe or inlet chute of a pipe conveying system for material, and one other pipeline is configured to conduct the material into a container.

36. The device according to claim 34, wherein material is configured to be conveyed from a first pipeline into at least one other pipeline by means of gravity.

37. The device according to claim 34, wherein material is configured to be conveyed from a first pipeline into at least one other pipeline by means of suction/a pressure difference.

38. A material collection and conveying system, in which material is infed in an inlet point and is conveyed along pipelines, such as conveying pipes or inlet chutes, under gravity and/or with a partial vacuum/pressure difference into one or more containers or to further processing, comprising:
the system material is configured to be conveyed from one first pipeline selectively with a device for changing the pathway of a medium between the one first pipeline and any of at least two other pipelines,
the first pipeline being arranged to be bendable at least at the point of its free end formed to be moveable, or in the proximity of said point, and in that in the device the means for changing the pathway of the medium comprises:
means for moving the free end of the first pipeline, and
coupling means for coupling and uncoupling the free end of the first pipeline with at least one other pipeline,
wherein the moving means of the free end of the first pipeline comprises at least one support means, which is arranged to be moved by at least one drive means and that the free end of the first pipeline is arranged to be moveable in relation to the support means.
